(19) United States
(12) Patent Application Publication
(10) Pub. No.: US 2009/0244782 A1
(43) Pub. Date: Oct. 1, 2009

(54) DISK DRIVE

(75) Inventor: Shigeru KAGAWA, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki (JP)

(21) Appl. No.: 12/410,953

(22) Filed: Mar. 25, 2009

(30) Foreign Application Priority Data
Mar. 26, 2008 (JP) 2008-080582

(51) Int. Cl. G11B 5/48

(52) U.S. Cl. 360/245.8; G9B/5.147

(57) ABSTRACT

A disk drive has: a disc-shape information recording medium; a swing arm having a base and a pair of arm sections extended along the surface and backside of the information recording medium; and two opposed connecting boards attached to the arm sections and each having an arm-side conductor pattern. The disk drive further has a circuit board with a signal-processing circuit processing a signal; and a relay board relaying the signal between the circuit board and the swing arm and having one end fixed to the circuit board and the other end provided with a fixed section fixed to the swing arm. The fixed section has a connection piece provided on a leading-end side of the fixed section, sandwiched between the connecting boards in a direction intersecting the connecting boards, and having a circuit-side conductor pattern connected to the arm-side conductor pattern at an edge contacting the connecting board.

### CROSS-REFERENCE TO RELATED APPLICATIONS

This application is based upon and claims the benefit of priority of the prior Japanese Laid-open Patent No. 2008-080582, filed on Mar. 26, 2008, the entire contents of which are incorporated herein by reference.

### FIELD

The embodiment discussed herein is directed to a disk drive.

### BACKGROUND

Recently, with the advance of the computer technology, there is also increasingly developed a technology associated with a device incorporated in a computer or a peripheral device externally connected to the computer. A disk drive is well known as one of the technologies. The disk drive includes a disc-shape information storage medium such as a magnetic disk, and the disk drive has a function of recording information by writing the information in the information storage medium and a function of reproducing the information by reading the information from the information storage medium in which the information is written.

FIG. 1 is a view illustrating an internal structure of a Hard Disk Drive (HDD), which is an example of a conventional disk drive.

In a hard disk drive (HDD) 900 of FIG. 1, a disc-shape magnetic disk 910, a swing arm 920, and a control circuit board 950 are provided in a housing 900H. The information can be recorded in a surface and a backside of the disc-shape magnetic disk 910. The swing arm 920 has a pair of arm sections 921 and 923 (see FIG. 3) extended along the surface and the backside of the disc-shape magnetic disk 910. A control circuit is formed in the control circuit board 950. HDD 900 also includes a relay board 960. The control circuit board 950 is fixed to the housing 900H. The relay board 960 relays a signal between the control circuit board 950 fixed to the housing 900H and the swing arm 920 which is of a movable member. The relay board 960 is formed by a belt-shape FPC (Flexible Printed Circuit) board. A fixed section 961 located on one side of the relay board 960 is attached to the swing arm 920, and the other side is attached to the control circuit board 950.

Examples of the connection structure between the relay board and the swing arm of HDD include a structure in which a pin provided in the swing arm is inserted in a hole of the relay board and a structure in which a conductor disposed in the swing arm and a conductor disposed in the relay board are overlapped with and soldered to each other (for example, see Japanese Laid-open Patent Publication No. 9-128911).

FIG. 2 is a view illustrating the swing arm of HDD of FIG. 1 when viewed from above, and FIG. 3 is a view illustrating the swing arm when viewed from a side surface. In FIGS. 2 and 3, the swing arm 920 is illustrated along with a part of the relay board 960. FIG. 3 illustrates a part of the side of the swing arm 920 in the part of the relay board 960 of FIG. 2 for the purpose of easy understanding of the connection portion. A position of the magnetic disk 910 is also illustrated in FIG. 3.

A fixed section 961 which is of a leading-end portion of the relay board 960 is fixed to an arm base 922 of the swing arm 920. Connection boards 912 and 932 made of FPC are provided on base-end sides of arm sections 921 and 923. The connection boards 912 and 932 have folded shapes, and ends of the folded portions are overlapped with the relay board 960. In the connection boards 912 and 932 and the relay board 960, plural terminals (not illustrated) are formed in the overlapped surfaces by a conductor pattern, and the terminals are soldered to each other.

The pair of arm sections 921 and 923 are disposed near the surface and backside of the one magnetic disk 910, respectively, and therefore the arm sections 921 and 923 are disposed close to each other. In a portion in which the connection boards 912 and 932 and the relay board 960 are overlapped with each other, a space is required to be able to solder the terminals disposed on the surfaces. Therefore, as illustrated in FIG. 3, the connection boards 912 and 932 are folded toward each other in an extended area located on a rear side of a disk area, which is at the rear ends of the arm sections 921 and 923 opposite to the leading ends thereof, and the connection boards 912 and 932 are extended toward the rear ends thereof. The connection boards 912 and 932 are widened so as to be separated from each other in a connection area behind the extended area. The connection boards 912 and 932 are widened larger than a distance between the arm sections 921 and 923 in the connection area, and an area enough to solder the terminals is ensured in the surface overlapped with the relay board 960.

A ground pin 924 and a Voice Coil Motor (VCM) pin 923 connected to a coil of VCM are provided in the arm base 922 of the swing arm 920, and the ground pin 924 and the VCM pin 923 are inserted in notches 913 and 914 formed in the relay board. In order to accurately position the relay board 960, the notch and the pin are preferably disposed close to the leading end of the relay board 960 as much as possible. Therefore, the connection boards 912 and 932 and the ground pin 924 are arrayed in a thick direction of HDD 900. As a result, the ground pin 924 and the VCM pin 923 are disposed in one of sides of the fixed section 961. In order to prevent the fixed section 961 from floating from the arm base 922 on the opposite side, the fixed section 961 needs to be positioned and fixed to the swing arm 920 by a screw 963 disposed at a diagonal position of the ground pin 924.

FIG. 4 is a view illustrating a part of a relay board of another conventional HDD which is different from HDD of FIG. 1. A fixed section 861 fixed to an arm base of a swing arm in a relay board 860 is mainly illustrated in FIG. 4.

Two connection boards 812 and 832 extending from two arms are overlapped with the relay board 860 of FIG. 4, and the terminals are soldered to each other in the overlapped portion. Two ground pins 824 and two VCM pins 823 pierce through a fixed section 861 of the relay board 860, and an amplifying IC 815 which amplifies a relay signal is also mounted on the fixed section 861. In addition to the electrical connection to the ground, the two ground pins 824 are used to position and fix the relay board 860 to the based of the swing arm. In order to enhance the positioning accuracy, the two ground pins 824 are disposed at diagonal positions of the belt-shape fixed section 861. The fixed section 861 is wider than the connection boards 812 and 832 being overlapped with the fixed section 861 in order that one of the ground pins 824 is disposed while avoiding the overlapped portion between the connection boards 812 and 832 and the fixed section 861.

FIG. 5 is a view illustrating a part of a relay board of still another conventional HDD which is different from HDD of FIG. 4. A fixed section 761 fixed to a base of a swing arm in a relay board 760 is illustrated in FIG. 5.

The relay board 760 of FIG. 5 is a relay board which is used in HDD having two magnetic disks, and four connection boards 712, 732, 752, and 772 extended from four arms are connected to the relay board 760. The relay board 760 is positioned and fixed to the swing arm by a screw 763.

### SUMMARY

A disk drive according to an embodiment of the present invention includes:

a disc-shape information recording medium in which information is recorded in a surface and a backside thereof;

a swing arm which includes a base and a pair of arm sections, the arm sections being extended along the surface and backside of the information recording medium while rear ends of the arm sections are fixed to the base;

a pair of heads which are respectively provided at leading-end portions of the arm sections to record information in the information recording medium;

a pair of connecting boards which are respectively attached to the arm sections while facing each other, each of the connecting boards having an arm-side conductor pattern in the facing surface thereof, the arm-side conductor pattern being electrically connected to the head;

a circuit board in which a signal processing circuit is provided, the signal processing circuit processing a signal indicating the information recorded by the head; and

a relay board which relays the signal between the circuit board and the swing arm, the relay board having one end fixed to the circuit board and the other end provided with a fixed section fixed to the swing arm,

wherein the fixed section comprises a connection piece on a leading-end side of the fixed section, the connection piece being sandwiched between the pair of connecting boards in a direction intersecting the connecting board, the connection piece having a circuit-side conductor pattern connected to the arm-side conductor pattern at an edge contacting the connecting board.

Additional objects and advantages of the invention will be set forth in part in the description which follows, and in part will be obvious from the description, or may be learned by practice of the invention. The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a view illustrating an internal structure of a conventional HDD;

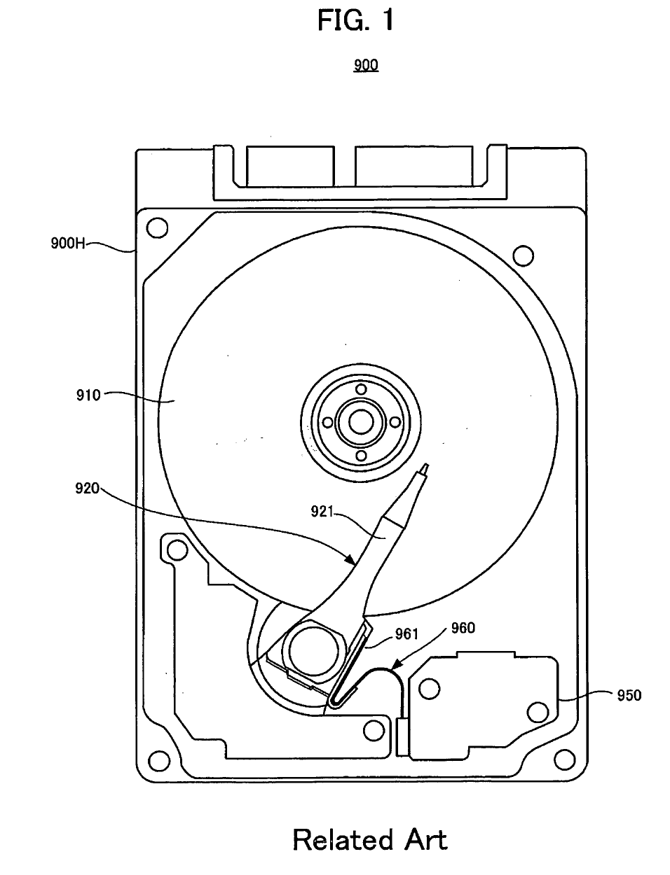

FIG. 2 is a view illustrating a swing arm of HDD of FIG. 1 when viewed from above;

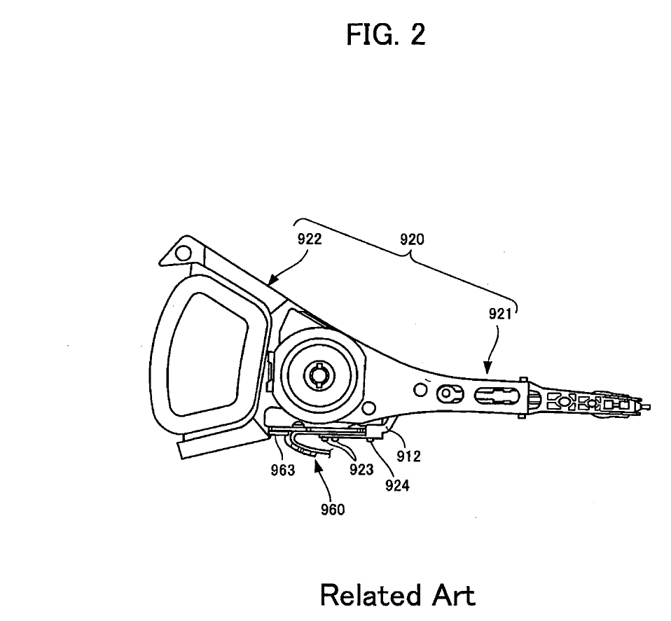

FIG. 3 is a view illustrating the swing arm when viewed from a side surface;

FIG. 4 is a view illustrating a part of a relay board of another conventional HDD which is different from HDD of FIG. 1;

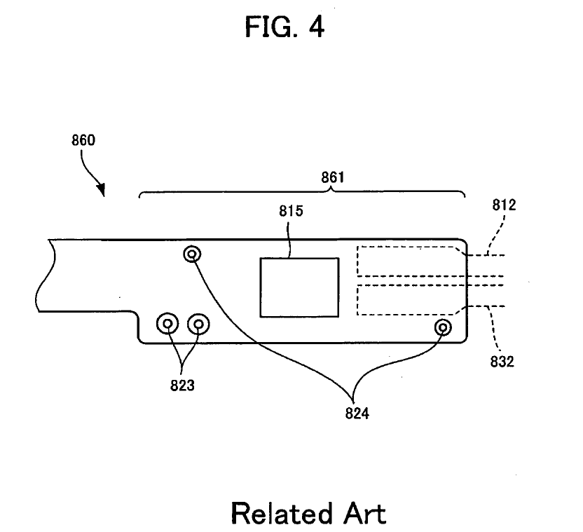

FIG. 5 is a view illustrating a part of a relay board of still another conventional HDD which is different from HDD of FIG. 4;

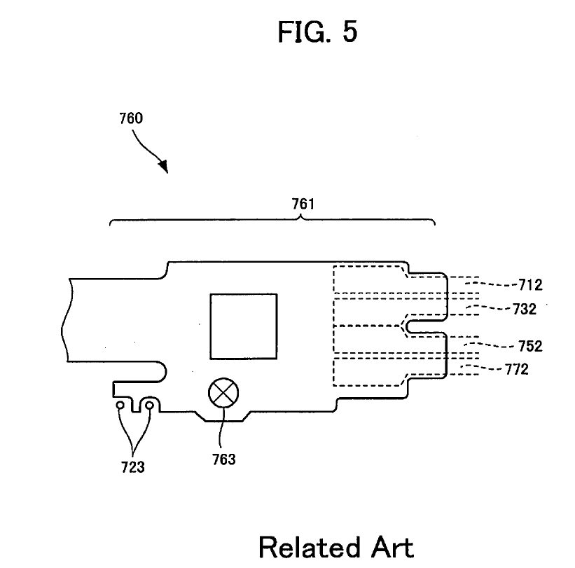

FIG. 6 is a view illustrating an internal structure of HDD which is of a specific embodiment of a disk drive;

FIG. 7 is a view illustrating a swing arm and a control circuit board of HDD of FIG. 6 when viewed from above;

FIG. 8 is a view illustrating the swing arm of HDD of FIG. 6 when viewed from a side surface;

FIG. 9 is an exploded perspective view illustrating components of the swing arm and control circuit board of HDD of FIG. 7;

FIG. 10 is a partially enlarged view of the relay board of FIG. 9;

FIG. 11 is an enlarged perspective view illustrating a portion which contacts a connecting board in the relay board of FIG. 7; and

FIG. 12 is a view illustrating a positional relationship between the relay board and the connection board of FIG. 11.

### DESCRIPTION OF EMBODIMENT(S)

A specific embodiment of the disk drive will be described with reference to the drawings.

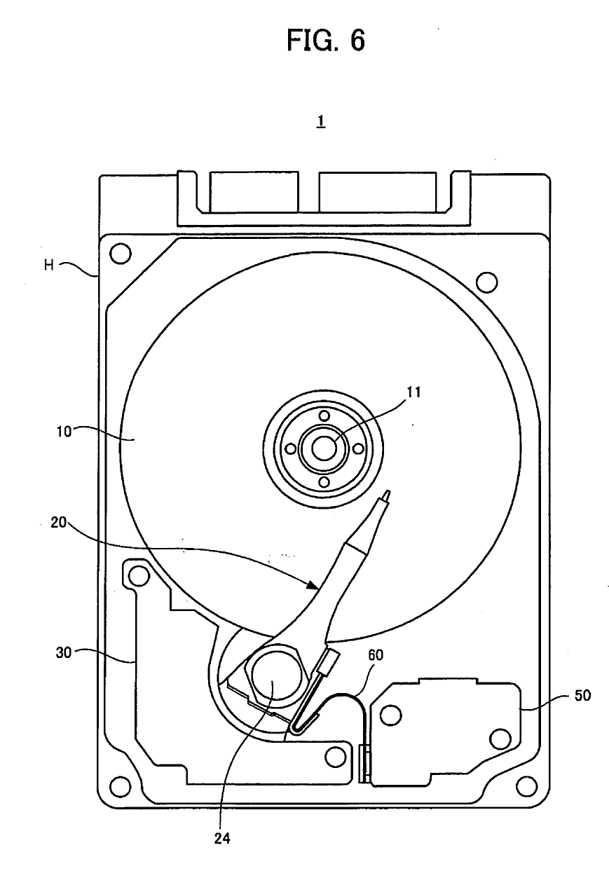

FIG. 6 is a view illustrating an internal structure of a Hard Disk drive (HDD) which is of a specific embodiment of the disk drive.

In a hard disk drive (HDD) 1 of FIG. 6, a disc-shape magnetic disk 10, a swing arm 20 which is moved along the surface and backside of the magnetic disk 10, a control circuit board 50, and a relay board 60 which relays a signal between the swing arm 20 and the control circuit board 50 are provided in a housing H. The magnetic disk 10 corresponds to an example of the information recording medium of the present invention.

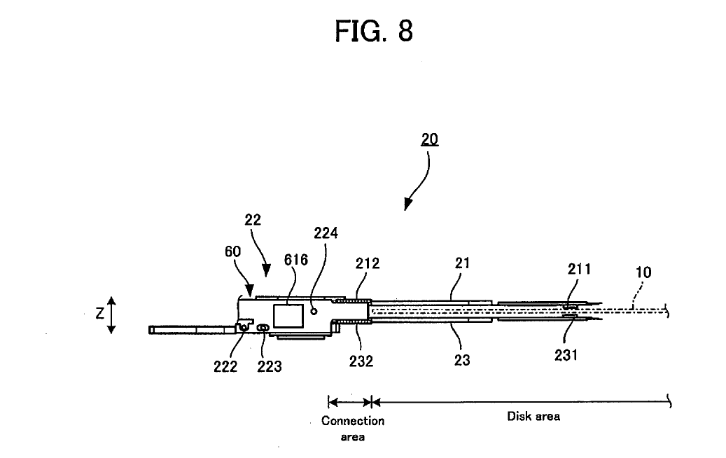

The magnetic disk 10 is rotated about a rotating shaft 11, and information is magnetically recorded in both the surface and backside of the magnetic disk 10. The swing arm 20 is rotatably supported by the bearing 24 in the housing H, and the swing arm 20 is turned about the bearing 24 within a range of a predetermined angle, thereby moving heads 211 and 231 (see FIG. 8) along the surface and backside of the magnetic disk 10. The actuator 30 is used to drive the bearing 24. The relay board 60 is a flexible belt-shape board which is formed by FPC (Flexible Printed Circuit), one of ends of the relay board 60 is fixed to the control circuit board 50, and the other end is fixed to the swing arm 20. The relay board 60 relays a signal between the control circuit board 50 fixed to the housing H and the swing arm 20 rotatably supported in the housing H.

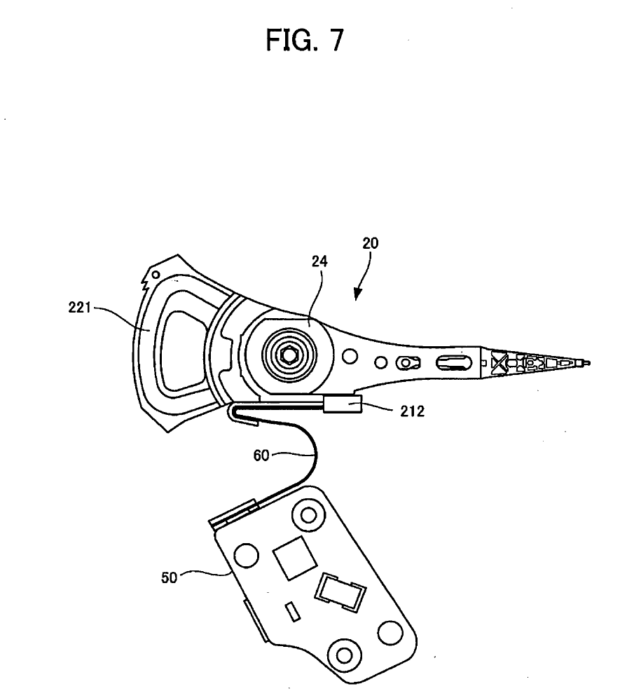

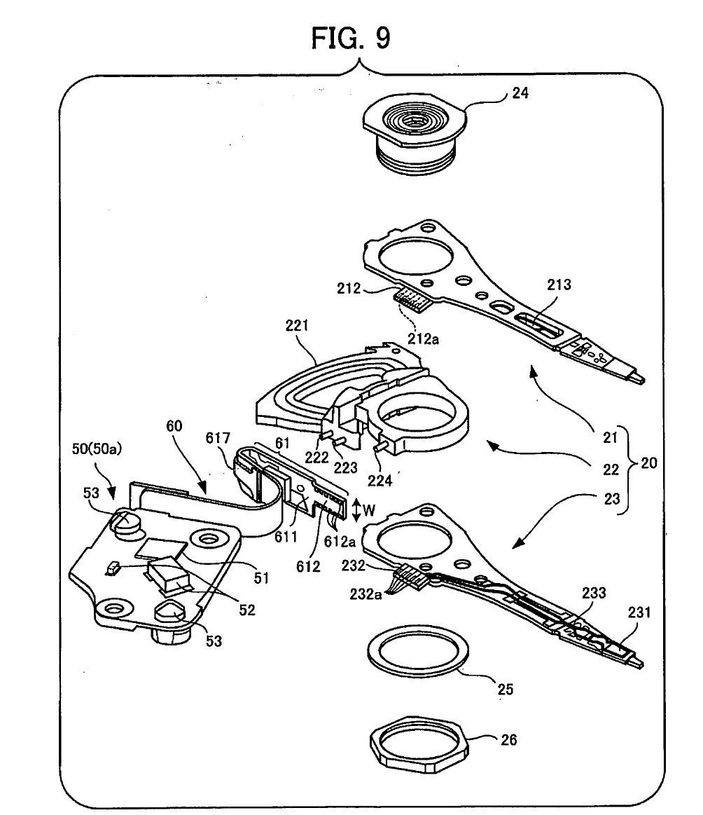

FIG. 7 is a view illustrating the swing arm 20 and control circuit board 50 of HDD of FIG. 6 when viewed from above, and FIG. 8 is a view illustrating the swing arm 20 when viewed from a side surface. FIG. 9 is an exploded perspective view illustrating components of the swing arm 20 and control circuit board 50 of HDD of FIG. 7.

As illustrated in FIG. 8 particularly, the swing arm 20 includes an arm base 22 and a pair of arm sections 21 and 23. The arm sections 21 and 23 are extended along the surface and backside of the magnetic disk 10 while rear ends of the arm sections 21 and 23 are fixed to the arm base 22. The arm sections 21 and 23 are fixed to the arm base 22 while facing each other. As illustrated in FIG. 9 particularly, the arm sections 21 and 23 as well as the arm base 22 are integrally formed by attaching a spacer 25 and a nut 26 to the bearing 24. The bearing 24 pierces through the arm sections 21 and 23 and the arm base 22. The arm base 22 is turned about the bearing 24 which is of a turning shaft. The arm base 22 corresponds to an example of the base of the present invention.

A pair of heads 211 and 231 (see FIG. 8) which records information in the magnetic disk 10 is provided in leading-end portions of the arm sections 21 and 23. As used herein, “leading end” and “rear end” are not only for the arm sections 21 and 23 but also used for an orientation in the whole of the swing arm 20. Connecting boards 212 and 232 are fixed to a neighborhood of the rear end of the arm sections 21 and 23, more particularly, a position adjacent to a rear-end side of a disk area where the magnetic disk 10 is disposed. While facing each other, the connecting boards 212 and 232 are attached so as to be projected from the arm sections 21 and 23. In the connecting boards 212 and 232, arm-side conductor patterns 212a and 232a are formed in the surfaces facing each other, and the arm-side conductor patterns 212a and 232a are electrically connected to heads 211 and 231 through leads 213 and 233. A coil 221 of a Voice Coil Motor (VCM) is provided in the arm base 22, and VCM drives the swing arm 20 in cooperation with the actuator 30. Two VCM pins 222 and 223 and a ground pin 224 are also provided in the arm base 22. The VCM pins 222 and 223 are terminals which supply an electric power to the coil 221, and the ground pin 224 is a terminal which supplies a ground level to the swing arm 20. The coil 221 corresponds to an example of the drive section, the ground pin 224 corresponds to an example of the first terminal projection, and the VCM pin 223 corresponds to an example of the second terminal projection, according to the present invention.

A semiconductor element 51 and other electronic components 52 are mounted on the control circuit board 50 which controls each section of the HDD 1. A signal processing circuit 50a is formed in the control circuit board 50, and the signal processing circuit 50a processes a signal indicating information recorded by the heads 211 and 231. The control circuit board 50 is fixed to the housing H by a screw 53. The control circuit board 50 corresponds to an example of the circuit board according to the present invention, and the signal processing circuit 50a corresponds to an example of the signal processing circuit according to the present invention.

The relay board 60 includes a fixed section 61 on an end opposite to an end connected to the control circuit board 50, and the fixed section 61 is fixed to the swing arm 20. The fixed section 61 includes a positioning section 611 which is positioned and fixed to the swing arm 20 and a connection piece 612 which is projected from the leading end of the positioning section 611. That is, the positioning section 611 is disposed closer to the rear-end side than the connection piece 612. The fixed section 61 is connected to the swing arm 20 at both the positioning section 611 and the connection piece 612. A reinforcing member 617 formed by a sheet metal is provided in the relay board 60 in order to reinforce the fixed section 61. A relay processing IC 616 is mounted on the positioning section 611 by soldering, and the relay processing IC 616 amplifies the signal relayed by the relay board 60.

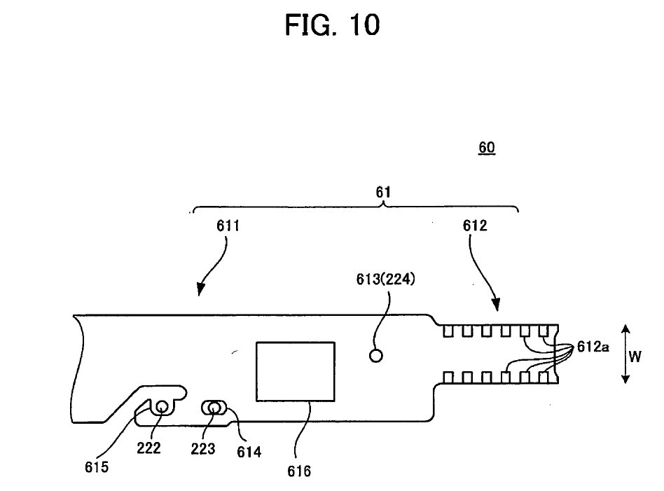

FIG. 10 is a partially enlarged view of the relay board 60.

As illustrated in FIG. 10 particularly, the connection piece 612 is a belt-shape portion projected from positioning section 611, and the connection piece 612 has a width W equal to a distance between the arm sections 21 and 23. In the connection piece 612, circuit-side conductor patterns 612a are formed at both side edges contacting the connecting boards 212 and 232. The positioning section 611 also has a substantially belt shape. A ground terminal hole 613 is formed at a position adjacent to the connection piece 612 of the positioning section 611, and the ground pin 224 of the arm base 22 is inserted into the ground terminal hole 613. A VCM terminal hole 614 is formed at a substantially diagonal position of the ground terminal hole 613 of the positioning section 611, and the VCM pin 223 is inserted into the VCM terminal hole 614. A VCM terminal notch 615 is also provided adjacent to the VCM terminal hole 614, and the VCM pin 222 is inserted into the VCM terminal notch 615. A diameter of the ground terminal hole 613 is substantially equal to a diameter of the ground pin 224. Although the VCM terminal hole 614 is formed to have a long shape, a shorter diameter of the VCM terminal hole 614 is substantially equal to a diameter of the VCM pin 223. Conductor patterns electrically conducted to the control circuit board 50 are formed at edges of the ground terminal hole 613, VCM terminal hole 614, and VCM terminal notch 615. Conductor pattern electrically conducted to the control circuit board 50 are also formed in the circuit-side conductor pattern 612a and the relay processing IC 616. However, the conductor patterns for establishing the conduction are omitted in the drawing for the sake of easy recognition of the arrangements of other components. The ground terminal hole 613 corresponds to an example of the first terminal hole according to the present invention, and the VCM terminal hole 614 corresponds to an example of the second terminal hole according to the present invention.

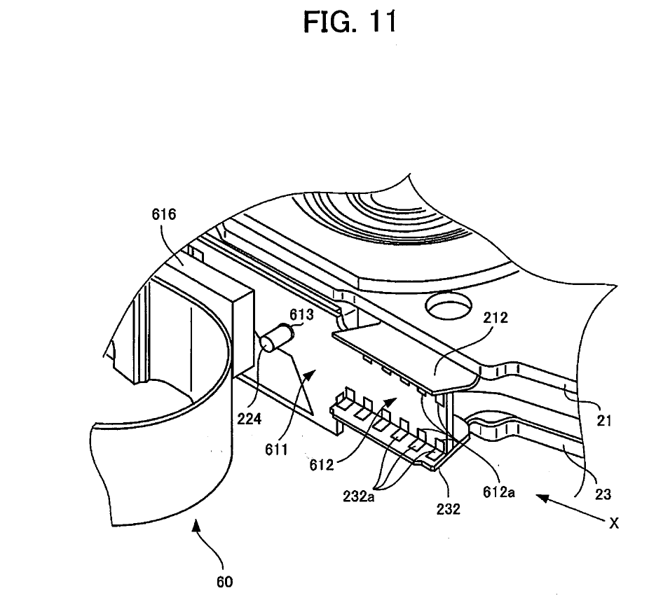

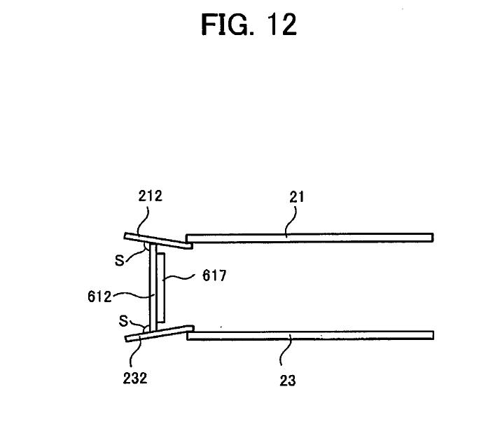

FIG. 11 is an enlarged perspective view illustrating a portion of the relay board 60 illustrated in FIG. 7, which portion contacts the connecting boards 212 and 232. FIG. 12 is a view illustrating a positional relationship between the relay board 60 and the connection boards 212 and 232 of FIG. 11. FIG. 12 schematically illustrates the positional relationship between the relay board 60 and the connecting boards 212 and 232 when viewed from an X-direction of FIG. 11.

As illustrated in FIGS. 11 and 12, the connection piece 612 is sandwiched between the pair of connecting boards 212 in a direction intersecting the connecting boards 212 and 232, and the circuit-side conductor pattern 612a and the arm-side conductor patterns 212a and 232a of the connecting boards 212 and 232 are connected by solder S. In FIG. 11, the solder S is omitted for the sake of easy recognition of the position of the arm-side conductor patterns 212a and 232a of the connecting boards 212 and 232.

In order to attach the relay board 60 to the swing arm 20 to form the structure illustrated in FIGS. 8, 11, and 12, the ground pin 224 of the swing arm 20 is inserted in the ground terminal hole 613, and the positioning section 611 is attached to the arm base 22 while the VCM pin 223 is inserted in the VCM terminal hole 614. At this point, the connection piece 612 is inserted so as to be sandwiched between the connecting boards 212 and 232. The diameter of the ground terminal hole 613 is substantially equal to the diameter of the ground pin 224, and the shorter diameter of the VCM terminal hole 614 is substantially equal to the diameter of the VCM pin 223, thereby accurately positioning the positioning section 611 with respect to the arm base 22. Because the connection piece 612 has the width W equal to the distance between the arm sections 21 and 23 while slightly larger than the distance between the connecting boards 212 and 232, the connection piece 612 intrudes between the connecting boards 212 and 232 to outwardly push the connecting boards 212 and 232. Accordingly, the inserted connection piece 612 is retained by elastic forces of the connecting boards 212 and 232. The connection piece 612 next to the positioning section 611 is accurately positioned to the connecting boards 212 and 232. Then, the circuit-side conductor pattern 612a and the arm-side conductor patterns 212a and 232a of the connecting boards 212 and 232 are connected by soldering. The edge of the ground terminal hole 613 and the ground pin 224, the edge of the VCM terminal hole 614 and the VCM pin 223, and the edge of the VCM terminal notch 615 and the VCM pin 222 are also connected by soldering, respectively. Thus, the relay board 60 is attached to the swing arm 20.

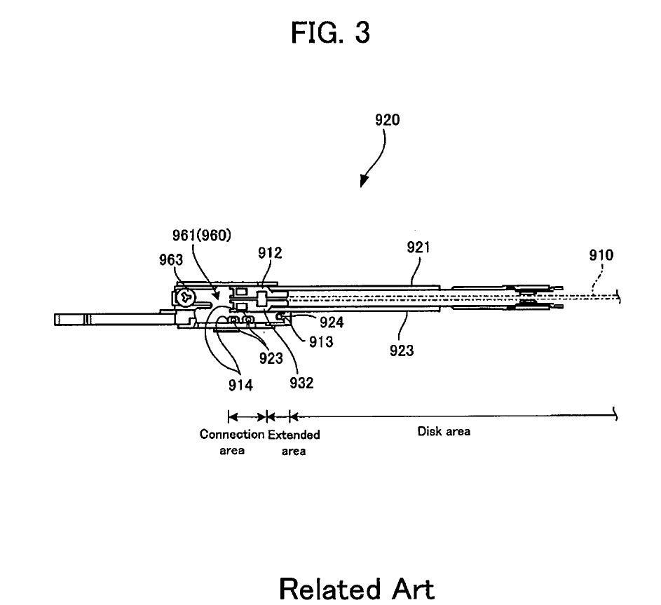

In the HDD1, the edge of the relay board 60 and the edges of the connecting boards 212 and 232 are brought into contact with each other while the surface of the relay board 60 and the surfaces of the connecting boards 212 and 232 are not overlapped with each other. Therefore, the extended area where the board is drawn to ensure the soldering connection area between the conductors is eliminated unlike the conventional technique illustrated in FIG. 3. Accordingly, the mounting area on the fixed section 61 of the relay board 60 is decreased, and the mounting area can effectively be utilized such that other components are disposed. The HDD 1 can be miniaturized by removing the unnecessary area from the fixed section 61 of the relay board 60. For example, in the HDD 1 of the specific embodiment, the ground pin 224 and the ground terminal hole 613 are disposed not at the position where the ground pin 224 and the ground terminal hole 613 are aligned with the connecting boards 212 and 232 in a height direction Z which is of a thickness direction of HDD 1, but at the position adjacent to the connection piece 612, that is, at a level between the connecting boards 212 and 232. Accordingly, compared with the conventional structure in which the ground pin and the ground terminal hole are aligned with the arm section, the width of the relay board can be reduced to achieve the low-profile HDD.

In the substantially-belt-shape positioning section 611, the ground pin 224 is disposed at the substantially diagonal position of the VCM pin 223, so that the positioning section 611 can accurately be positioned by the ground pin 224 and the VCM pin 223. Accordingly, another pin except for the ground pin 224 and VCM pins 223 and 222 is not required to perform the accurate positioning, so that the production cost can be reduced.

In the specific embodiment, the HDD 1 has the magnetic disk 10 and the pair of arm sections 21 and 23 which are of examples of the disk drive according to the present invention. Alternatively, the disk drive may include an additional magnetic disk and an additional arm section.

In the specific embodiment, the HDD 1 has the flexible belt-shape FPC relay board 60 which is of an example of the relay board section according to the present invention. Alternatively, the relay board section is not limited to the relay board 60 which is entirely formed by FPC. For example, the relay board section may have a partially flexible structure.

According to the above-described embodiment of the disk drive, the connection piece of the relay board is sandwiched between the pair of connecting boards facing each other, in the direction intersecting the connecting board, and the circuit-side conductor pattern provided at the edge of the connection piece is connected to the arm-side conductor pattern provided in the surface of the connecting board. According to the above-described embodiment, because the surfaces of the connecting board and the connection piece of the relay board are not brought into contact with each other, the conductors can be connected to each other even if a width of the connection piece is equal to or less than the distance between the pair of arms. Therefore, the connection portion is accommodated between the two connecting boards facing each other, and it is not necessary to provide an area where the connecting board is extended. Accordingly, the area of the fixed section of the relay board can effectively be utilized for other uses. The relay board is miniaturized as the area used to connect the connecting board is decreased, so that the disk drive can be miniaturized.

Thus, as described above, in the disk drive of the present embodiment, the area on the relay board can effectively be utilized to miniaturize the disk drive.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A disk drive comprising:
a disc-shape information recording medium in which information is recorded in a surface and a backside thereof;
a swing arm which includes a base and a pair of arm sections, the arm sections being extended along the surface and backside of the information recording medium while rear ends of the arm sections are fixed to the base;
a pair of heads which are respectively provided at leading-end portions of the arm sections to record information in the information recording medium;
a pair of connecting boards which are respectively attached to the arm sections while facing each other, each of the connecting boards having an arm-side conductor pattern in the facing surface thereof, the arm-side conductor pattern being electrically connected to the head;
a circuit board in which a signal processing circuit is provided, the signal processing circuit processing a signal indicating the information recorded by the head; and
a relay board which relays the signal between the circuit board and the swing arm, the relay board having one end fixed to the circuit board and the other end provided with a fixed section fixed to the swing arm,
wherein the fixed section comprises a connection piece on a leading-end side of the fixed section, the connection piece being sandwiched between the pair of connecting boards in a direction intersecting the connecting board, the connection piece having a circuit-side conductor pattern connected to the arm-side conductor pattern at an edge contacting the connecting board.

2. The disk drive according to claim 1, wherein the fixed section has a belt-shape positioning section at a position located closer to a rear-end side than the connection piece, the positioning section is positioned with respect to the swing arm and fixed to the swing arm, and the fixed section has a first terminal hole formed at a position adjacent to the connection piece and within the positioning section, and
the swing arm has a first terminal projection inserted into the first terminal hole.

3. The disk drive according to claim 2, wherein the relay board has a second terminal hole formed at a substantially-diagonal position with respect to the first terminal hole in the positioning section, and
the swing arm has a second terminal projection inserted into the second terminal hole.

4. The disk drive according to claim 3, wherein the swing arm includes a drive section which drives the swing arm,
the first terminal projection inserted into the first terminal hole is one of a terminal through which electric power is supplied to the drive section and a terminal through which a ground level is supplied to the swing arm, and
the second terminal projection inserted into the second terminal hole is the other of the terminal through which electric power is supplied to the drive section and the terminal through which the ground level is supplied to the swing arm.
